(19) United States
(12) Patent Application Publication
(10) Pub. No.: US 2019/0183118 A1
(43) Pub. Date: Jun. 20, 2019

(54) SPRAY DRIFT REDUCTION

(71) Applicant: Croda, Inc., Edison, NJ (US)

(72) Inventors: Logan Peter Dempsey, Claymont, DE (US); Gregory James Lindner, Wilmington, DE (US); Jinxia Susan Sun, HOPEWELL, NY (US)

(73) Assignee: Croda, Inc., Edison, NJ (US)

(21) Appl. No.: 16/309,541

(22) PCT Filed: Jun. 26, 2017
(86) PCT No.: PCT/US2017/039234

§ 371 Date: Dec. 13, 2018

Related U.S. Application Data
(60) Provisional application No. 62/357,510, filed on Jul. 1, 2016.

(51) Int. Cl. A01N 25/30; A01N 25/10; A01N 25/04; C08J 3/03

(52) U.S. Cl. CPC A01N 25/30; A01N 25/10; C08J 2300/14; C08J 3/03; A01N 25/04

(57) ABSTRACT

Spray drift reductants for agrochemical formulations for use in spray drift reduction in agrochemical formulations which contain actives and/or micronutrients. The reductants are selected from alkoxylated polyol or polyamine which is optionally acyl terminated, and the formulation may optionally comprise non-ionic alkoxylate. There is also provided a method of making the formulation, and the use of the formulation in reducing spray drift on application of the agrochemical formulation to vegetation.

### CROSS-REFERENCE TO RELATED APPLICATIONS

This application is related to and claims the benefit of U.S. Provisional Patent Application No. 62/357,510, filed Jul. 1, 2016, the contents of which are incorporated herein by reference.

The present invention relates to spray drift reductants for agrochemical formulations, particularly for use in spray drift reduction, and more especially for use as spray drift reductants and a method of reducing spray drift in agrochemical formulations comprising said compounds with one or more agrochemical actives and/or nutrients.

Many agricultural pesticides, including insecticides, fungicides, herbicides, miticides, and plant growth regulators, are applied in the form of a liquid composition. In addition to the pesticide, such liquid compositions typically include one or more compounds intended to improve one or more properties of the liquid composition, such as for example, storage stability, ease of handling, and/or pesticide efficacy against target organisms.

The field of agricultural spray drift has been active for several decades with significant findings published on the importance of agriculture spray mixture composition and properties on the potential for small droplet formation and the impact of this effect on drift potential. In the overwhelming majority of circumstances for the citations reviewed herein relating to ground level boom sprayer applications, although the inability to identify or describe a single predictive model using the spectrum of properties measured for the spray mixture was reported, there was significant agreement across researchers throughout the past 20 years that the effectiveness of any drift reduction technology (DRT) is a function not only of the spray system design and operating parameters, but that each selection of design and engineering parameters (nozzle type, fluid pressure, flow rate or orifice size, and spray angle) is influenced, in many cases differently, by the composition and properties of the spray mixture applied.

As has been captured by the summarised research in great detail, each spray mixture evaluated is different and is composed of a formulated pesticide active ingredient and more frequently several actives appearing in different formulations. Each pesticide formulation would be expected to exert an independent effect on droplet size and spray quality when applied separately since they contain independent arrays of formulants, many of which are surface active or contribute to the concentration of dispersed phases in the spray mixture. The research is clear in the importance of each of these materials to the final properties of the mixture and also to the droplet size distribution and spray quality produced by the mixture when applied through a series of nozzles and under differing spray conditions.

When these formulations are combined into a single application, it is reasonable to conclude that the number of component interactions will increase and that the types and strength of these interactions will change based on changes in relative dilution rates and the components and concentrations appearing in the final spray mixture.

Added to this will be the influence exerted by other spray modifiers or adjuvants which are also contributing components and effects that are a function of their independently selected formulants where each of which has a differing effect on droplet size and spray quality. Frequently, the component and effect contributions from the adjuvants used can dominate spray properties, notably when the adjuvant is selected for materials and compositions known no strongly influence the droplet size distribution and spray quality of a mixture. To illustrate how sophisticated this research understanding has become, detailed descriptions of these spray component influences appeared over a decade ago to the point of describing differences in effect on critical droplet size criteria observed within a continuous series of analogous surfactant materials.

In light of this clearly demonstrated fact, the performance of a nozzle alone as the sole technology applied in the stated capacity to reduce pesticide drift (one either already certified or in pursuit of certification as a Drift Reduction Technology) cannot be certified for application using data developed with water as the spray mixture. This practice is now well recognized to be misplaced and has been inappropriately oversimplified, especially when (1) a solution pesticide containing significant amounts of surfactant adjuvant is present and (2) other materials purposefully added to modify spray droplet size, pattern, or quality have been added.

The research cited clearly describes the capacity of a technology applied to reduce pesticide drift to be more accurately defined using a combination of the contribution from spray system design and operating parameters with the contribution from an appropriately representative admixture of diluted materials in the model spray mixtures. This mixture should in all cases include a suitable pesticide or pesticides along with a representative adjuvant system. The parties assessing the US EPA Drift Reduction Technology certification testing protocol need to consider and include this relevant research in the final adopted methodology.

There has been an interest in reducing drift of spray applied pesticides and the addition of high molecular weight water soluble polymers to spray compositions as a tank mix to increase droplet size and thereby reduce drift of pesticides in known, see, for example, U.S. Pat. Nos. 5,874,096 and 6,214,771. Such polymeric drift control additives tend to perform best within a relatively narrow range of concentration, for example, in spray compositions comprising from about 0.05 to 0.15 wt. % of such polymer. More recently other approaches, such as the use of certain “self-emulsifiable” esters as drift control agents, see US 2010/0113275, have been described.

There is a continuing interest in developing compounds for controlling drift of spray applied pesticides that exhibit high performance when present in a spray composition in low amount and that are relatively insensitive to the amount of adjuvant in the spray composition.

The agricultural non-ionic (NIC) adjuvant market in North America is typically dominated by nonylphenol ethoxylates with sales of around 10,000 tonnes per year.

Additional benefits suitable for adding value include improvements in limiting or reducing the formation of driftable fine droplets under select spray conditions.

The traditional approach for agrochemical formulations is addition of oils or polymers. However, these components are known to cause increases in droplet fines when the formulation is sprayed, and this is undesirable.

The present invention seeks to provide the use of compounds in agrochemical compositions in combination with one or more agrochemical active and/or nutrient, where the compounds may provide comparable (i.e. by not degrading the spray pattern) or improved properties with regard to spray drift compared to formulations used without spray drift reductants, or in comparison to existing spray drift reductants.

In addition, the present invention seeks to provide compounds which can be easily dispersed in to water based formulations for spray drift reduction, and which are effective at low concentration levels.

The present invention also seeks to provide the use of agrochemical concentrates and dilute formulations comprising said spray drift reductants. Additionally, the present invention seeks to provide a method of reducing spray drift, and a method of treating vegetation for pests or to provide nutrients.

According to a first aspect of the present invention there is provided a sprayable agrochemical formulation comprising;
i) at least one spray drift reductant is an alkoxylated polyol or polyamine which is optionally acyl terminated;
ii) optionally non-ionic alkoxylate; and
ii) optionally at least one agrochemical active and/or nutrient;
   wherein said formulation comprises in the range from 0.001 wt. % to 4 wt. % of the reductant.

According to a second aspect of the present invention there is provided a concentrate formulation suitable for making a sprayable agrochemical formulation of the first aspect, said concentrate comprising a spray drift reductant of an alkoxylated polyol or polyamine which is optionally acyl terminated.

According to a third aspect of the present invention there is provided a sprayable agrochemical formulation comprising;
i) in the range of from 0.001 wt. % to 4 wt. % spray drift reductant, wherein the reductant is an alkoxylated polyol or polyamine which is optionally acyl terminated, and is capable of reducing spray drift by at least 10%; and
ii) at least one agrochemical active and/or nutrient.

According to a fourth aspect of the present invention there is provided the use of an alkoxylated polyol or polyamine which is optionally acyl terminated, as a spray drift reductant in an agrochemical formulation comprising at least one agrochemical active and/or nutrient.

According to an fifth aspect of the present invention there is provided a method of reducing spray drift by using an agrochemical formulation of the first or third aspects, and/or a diluted concentrate formulation of the second aspect.

According to a sixth aspect of the present invention there is provided a method of treating vegetation to control pests and/or to provide nutrients, the method comprising applying a formulation of the first or third aspects, and/or a diluted concentrate formulation of the second aspect, either to said vegetation or to the immediate environment of said vegetation.

It has been found that alkoxylated polyol or polyamine which is optionally acyl terminated comprising agrochemical formulations, and in particular use of these compounds, provides for comparable (i.e. by not degrading the spray pattern), or improved drift control during spraying of said formulation. In particular, use of the alkoxylated polyol or polyamine which is optionally acyl terminated provides for better spray patterns and gives fewer driftable particles. The compound, is also found to be easily dispersible in water based formulations and effective at low concentration thereby allowing the formulator increased formulation space.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

It will be understood that, when describing the number of carbon atoms in a substituent group (e.g. ‘C₁ to C₆ alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

As used herein, the term ‘concentrate’ is well known in the agrochemical field, and refers to agrochemical compositions, which are designed to be diluted with water (or a water based liquid) to form the corresponding end-use agrochemical formulations, typically spray formulations. The concentrate is therefore formed and stored in a concentrated form, and diluted down to the desired strength prior to application.

As used herein, the term ‘drift’ refers to off-target movement of droplets of an agrochemical composition that is applied to a target pest or environment for the pest or to provide nutrients. Spray applied compositions typically exhibit decreasing tendency to drift with decreasing relative amount, typically expressed as a volume percentage of total spray applied droplet volume, of small size spray droplets, that is, spray droplets having a droplet size below a given value, typically a droplet size of less than 150 micrometers. Spray drift of pesticides in particular can have undesirable consequences such as, for example, unintended contact of phytotoxic pesticides with non-pest pest plants like crops or ornamental plants along with damage to such non-pest plants.

As used herein, the term ‘spray drift reductant’ refers to compounds which when added to a sprayable agrochemical formulation may provide a reduction in observed spray drift when compared to the formulation not comprising said agent.

The spray drift reductant is an alkoxylated polyol or polyamine which is optionally acyl terminated.

The spray drift reductant is an alkoxylated polyol or polyamine which is optionally acyl terminated, and may have a general structure (I):

R¹.[(AO)ₙ—R²]ₘ (I)

wherein
R¹ is the residue of a polyol or polyamine, each said polyol or polyamine having m active hydrogen atoms, where m is an integer of at least 2;
AO is an oxyalkylene group;
each n independently represents an integer in the range from 1 to 100;
each R² is independently represents hydrogen, or an acyl group represented by —C(O)R³ wherein each R³ independently represents a residue of polyhydroxyalkyl carboxylic acid, polyhydroxyalkenyl carboxylic acid, hydroxyalkyl carboxylic acid, hydroxyalkenyl carboxylic acid, oligomer of hydroxyalkyl carboxylic acid, or oligomer of hydroxyalkenyl carboxylic acid; and
wherein on average at least two R² groups per molecule are alkanoyl groups as defined.

The spray drift reductant of the present invention is at least notionally built up from the group R¹ that can be considered as the “core group” of the compound. This core group is the residue (after removal of m active hydrogen atoms) of a compound containing at least m active hydrogen atoms, preferably present in hydroxyl and/or amino groups, and more preferably present in hydroxyl groups only.

The term polyol is well known in the art, and refers to an alcohol comprising more than one hydroxyl group. The term ‘active hydrogen’ refers to the hydrogen atoms present as part of the hydroxyl groups of the polyol. Therefore, it will be understood that the integer m, being the number of active hydrogens in said polyol, is equivalent to the number of hydroxyl groups present for each polyol.

The term ‘polyol residue’ as used herein, unless otherwise defined, refers to an organic radical derived from a polyol by removal of m active hydrogen atoms, each hydrogen atom being from one of the hydroxyl groups present.

The term polyamine will also be similarly understood, although will have amino groups in place of hydroxyl groups.

Preferably the core group is the residue of an amino and/or hydroxyl comprising hydrocarbyl, particularly a C₃ to C₃₀ amino and/or hydroxyl comprising hydrocarbyl.

Examples of R¹ core groups include the residues of the following compounds after removal of m active hydrogen atoms:
glycerol and polyglycerols, especially diglycerol and triglycerol, the partial esters thereof, or any triglycerides containing multiple hydroxyl groups, for example castor oil;
tri- and higher polymethylol alkanes such as trimethylol ethane, trimethylol propane and pentaerythritol, and the partial esters thereof;
sugars, particularly non-reducing sugars such as sorbitol, mannitol, and lactitol, etherified derivatives of sugars such as sorbitan (the cyclic dehydro-ethers of sorbitol), partial alkyl acetals of sugars such as methyl glucose and alkyl;
(poly-)saccharides, and other oligo-/polymers of sugars such as dextrins, partially esterified derivatives of sugars, such as fatty acid esters, for example of lauric, palmitic, oleic, stearic and behenic acid, esters of sorbitan, sorbitol, and sucrose, aminosaccharides such as N-alkylglucamines and their respective N-alkyl-N-alkenoyl glucamides;
polyhydroxy carboxylic acids, especially citric and tartaric acids;
amines including di- and poly-functional amines, particularly alkylamines including alkyl diamines such as ethylene diamine (1,2-diaminoethane);
amino-alcohols, particularly the ethanolamines, 2-aminoethanol, di-ethanolamine and triethanolamine;
carboxylic acid amides such as urea, malonamide and succinamide; and
amido carboxylic acids such as succinamic acid.

Preferred R¹ core groups are residues of groups having at least 3, more preferably in the range from 4 to 10, particularly 5 to 8, and especially 6 free hydroxyl and/or amino groups.

The R¹ group preferably has a linear C₄ to C₇, more preferably C₆ chain. The hydroxyl or amino groups are preferably directly bonded to the chain carbon atoms. Hydroxyl groups are preferred. R¹ is preferably the residue of an open chain tetratol, pentitol, hexitol or heptitol group or an anhydro e.g. cycloether anhydro, derivative of such a group. In a particularly preferred embodiment, R¹ is the residue of, or a residue derived from, a sugar, more preferably a monosaccharide such as glucose, fructose or sorbitol, a disaccharide such as maltose, palitose, lactitol or lactose or a higher oligosaccharide. R¹ is preferably the residue of a monosaccharide, more preferably of glucose, fructose or sorbitol, and particularly of sorbitol.

The open chain form of R¹ groups is preferred; however groups including internal cyclic ether functionality can be used, and may be obtained inadvertently if the synthetic route exposes the group to relatively high temperatures or other conditions, which promote such cyclisation.

The index m is a measure of the functionality of the R¹ core group and the alkoxylation reactions will replace some or all of the active hydrogen atoms (dependant on the molar ratio of core group to alkoxylation group) in the molecule from which the core group is derived. Reaction at a particular site may be restricted or prevented by steric hindrance or suitable protection. The terminating hydroxyl groups of the polyalkylene oxide chains in the resulting compounds are then available for reaction with the above defined acyl compounds.

The index m will preferably be at least 3, more preferably in the range from 4 to 10, particularly 5 to 8, and especially 5 to 6. Mixtures may be, and normally are, employed, and therefore m when specified across a bulk amount of the reductant, can be an average value and may be non-integral.

The groups R² are the “terminating groups” of the (poly)alkylene oxide chains. The terminating groups are hydrogen or an acyl (also known as alkanoyl) group represented by —C(O)R³, where each R³ independently represents a residue of polyhydroxyalkyl carboxylic acid, polyhydroxyalkenyl carboxylic acid, hydroxyalkyl carboxylic acid, hydroxyalkenyl carboxylic acid, oligomer of hydroxyalkyl carboxylic acid, or oligomer of hydroxyalkenyl carboxylic acid

The hydroxylalkyl and hydroxyalkenyl carboxylic acids are of formula HO—X—COOH where X is a divalent saturated or unsaturated, preferably saturated, aliphatic radical containing at least 8 carbon atoms and no more than 20 carbon atoms, typically from 11 to 17 carbons and in which there are at least 4 carbon atoms directly between the hydroxyl and carboxylic acid groups.

Desirably the hydroxyalkyl carboxylic acid is 12-hydroxystearic acid. In practice such hydroxyalkyl carboxylic acids are commercially available as mixtures of the hydroxyl acid and the corresponding unsubstituted fatty acid. For example 12-hydroxystearic acid is typically manufactured by hydrogenation of castor oil fatty acids including the C₁₈ unsaturated hydroxyl acid and the non-substituted fatty acids (oleic and linoleic acids) which on hydrogenation gives a mixture of 12-hydroxystearic and stearic acids. Commercially available 12-hydroxystearic acid typically contains about 5 to 8% unsubstituted stearic acid.

The polyhydroxyalkyl or polyhydroxyalkenyl carboxylic acid is manufactured by polymerising the above mentioned hydroxyalkyl or hydroxyalkenyl carboxylic acid. The presence of the corresponding unsubstituted fatty acid acts as a terminating agent and therefore limits the chain length of the polymer. Desirably the number of hydroxyalkyl or hydroxyalkenyl units is on average from 2 to 10, particularly from about 4 to 8 and especially about 7. The molecular weight of the polyacid is typically from 600 to 3,000, particularly from 900 to 2,700, more particularly from 1,500 to 2,400 and especially about 2,100.

The residual acid value for the polyhydroxyalkyl or polyhydroxyalkenyl carboxylic acid typically is less than 50 mgKOH/g, and a preferable range is 30 to 35 mgKOH/g. Typically, the hydroxyl value for the polyhydroxyalkyl or polyhydroxyalkenyl carboxylic acid is a maximum of 40 mgKOH/g, and a preferable range is 20 to 30 mgKOH/g.

The oligomer of the hydroxyalkyl or hydroxyalkenyl carboxylic acid differs from the polymer in that termination is not by the unsubstituted corresponding fatty acid. Desirably it is a dimer of the hydroxylalkyl or hydroxyalkenyl carboxylic acid.

The oxyalkylene groups (AO) may be selected from groups of the formula —(C_{y}H_{2y}O)— where y is an integer selected from 2, 3, or 4. Preferably, y is 2 or 3.

The oxyalkylene group AO may be selected from oxyethylene, oxypropylene, oxybutylene, or oxytetramethylene. Preferably, the oxyalkylene group is selected from oxyethylene (EO) and/or oxypropylene (PO).

Where the oxyalkylene chain is homopolymeric, homopolymers of ethylene oxide or propylene oxide are preferred. More preferably, homopolymers of ethylene oxide are particularly preferred.

Where there is more than one oxyalkylene group present (i.e. where n is 2 or more) and at least two are part of the same oxyalkylene chain, the oxyalkylene groups may be the same or may be different along said oxyalkylene chain. In this embodiment, the oxyalkylene chain may be a block or random copolymer of differing oxyalkylene groups.

Usually, where co-polymeric chains of ethylene and propylene oxide units are used the molar proportion of ethylene oxide units used will be at least 50% and more usually at least 70%.

The number of alkylene oxide residues in the (poly)alkylene oxide chains, i.e. the value of the each parameter n, will preferably be in the range from 2 to 50, more preferably 3 to 20, and particularly 5 to 10.

The total number of alkylene oxide residues in general structure (I) (i.e. n×m) is preferably in the range from 10 to 300, more preferably 20 to 100, particularly 25 to 70, and especially 30 to 50.

Where the number of acyl residues in the molecule is significantly less than m, the distribution of such groups may depend on the nature of the core group and on the extent and effect of the alkoxylation of the core group. Thus, where the core group is derived from pentaerythritol, alkoxylation of the core residue may be evenly distributed over the four available sites from which an active hydrogen can be removed and on esterification of the terminal hydroxyl functions the distribution of acyl groups will be close to the expected random distribution. However, where the core group is derived from compounds, such as sorbitol, where the active hydrogen atoms are not equivalent, alkoxylation will typically give unequal chain lengths for the polyalkyleneoxy chains. This may result in some chains being so short that the other (longer) chains exert significant steric effects making esterification at the “short chain” terminal hydroxyl groups relatively difficult. Esterification then will generally preferentially take place at the “long chain” terminal hydroxyl groups.

The spray drift reductant of the invention can be made by firstly alkoxylating R¹ core groups containing m active hydrogen atoms, by techniques well known in the art, for example by reacting with the required amounts of alkylene oxide, for example ethylene oxide and/or propylene oxide. Some suitable alkoxylated products are commercially available, for example sorbitol 30 ethoxylate (Atlas™ G-2330), sorbitol 40 ethoxylate (Atlas™ G-2004), sorbitol 50 ethoxylate (Atlas™ G-2005), and trimethylolpropane 40 ethoxylate 10 propoxylate (Emkarox™ VG-305W). All are available ex Croda. Other alkoxylation products include sorbitol 12 ethoxylate and sorbitol 100 ethoxylate.

The second stage of the process preferably comprises reacting the aforementioned alkoxylated species with a polyhydroxyalkyl (alkenyl) carboxylic acid and/or a hydroxyalkyl(alkenyl) carboxylic acid under standard catalysed esterification conditions at temperatures up to 250° C.

The molar ratio of alkoxylated product to a polyhydroxyalkyl (alkenyl) carboxylic acid and/or a hydroxyalkyl(alkenyl) carboxylic acid preferably ranges from 1:2 to 1:40.

The spray drift reductant is a liquid with a molecular weight ranging from 3,000 to 8,000. The reductant is preferably a star block copolymer.

One of the key benefits of the spray drift reductant is that it can have a wide range of HLB depending on whether the R³ group is a residue of a polyhydroxyalkylcarboxylic acid, a hydroxyl alkylcarboxylic acid, an oligomer of a hydroxyalkyl carboxylic acid, or a mixture thereof and also depending on the ratio of each of these ingredients. The typical range of HLB is from 1.3 to 15.0.

In one preferred embodiment of the invention the reductant is prepared by reaction of the alkoxylated core group R¹ with a hydroxyl alkylcarboxylic acid in a molar ratio of from 1:14 to 1:19. Preferably the reductant prepared by this route has an HLB of between 6 and 9 and a molecular weight between 6,500 and 8,000.

In a further preferred embodiment of the invention the spray drift reductant is prepared by reaction of the alkoxylated core group R¹ with a mixture of a polyhydroxyalkyl carboxylic acid and a hydroxyl alkylcarboxylic acid where the molar ratio of alkoxylated core group to mixture of acids. Preferably the molar ratio of alkoxylated core group to mixture of acids ranges from 1:1 to 1:6. Preferably the reductant prepared by this route has a molecular weight between 3,000 and 4,000.

In a further preferred embodiment of the invention the spray drift reductant is prepared by reaction of the alkoxylated core group R¹ with a polyhydroxyalkyl carboxylic acid where the molar ratio of alkoxylated core group to acid preferably ranges from 1:14 to 1:19. Preferably the reductant prepared by this route has a molecular weight between 6,500 and 8,000.

Preferably, the amount of reductant comprised in the concentrate is in the range from 0.5 wt. % to 40 wt. % as a percentage of the total concentrate weight. More preferably, from 2 wt. % to 30 wt. %. Most preferably, 6 wt. % to 25 wt. %. Further preferably, 10 wt. % to 20 wt. %.

The spray drift reductants may preferably be liquid at room temperature and pressure. Most preferably, the spray drift reductants are liquid and remain as liquid and free from suspended solids in the sprayable agrochemical formulation at temperatures down to 0° C. for at least 24 hours.

The spray drift reductants may also have low or no aquatic toxicity, and be acceptable for food use. Specifically, the reductants may be selected from those which avoid classification as hazardous under the Globally Harmonized System (GHS), that are acceptable for organic production as defined by the USDA National Organic Program, and/or that are acceptable for use as additives to food as defined by the US Food and Drug Administration, the UN WHO Joint Expert Committee on Food Additives (JECFA) or related EU food safety regulations.

The spray drift reductant may preferably be non-self-emulsifiable. Said reductant may therefore need to be emulsified, and said emulsification may be achieved by mechanical action, such as homogenisation, or by addition of an emulsifier compound.

The agrochemical formulation according to the present invention may also contain components, such as surfactant materials which form part of the system. Said surfactants may include surfactant dispersants.

Suitable surfactants include relatively hydrophilic surfactants, e.g. having a HLB value of greater than 10, preferably greater than 12. The surfactants may alternatively be relatively hydrophobic surfactants being are surfactants which are not fatty esters of C₃ to C₈ polyol or oligomers thereof having 2-5 repeat units, and may have HLB values of less than 10, preferably less than 8.

Relatively hydrophilic surfactants include alkoxylate surfactants with an average in the range from about 10 to about 100 alkylene oxide, particularly ethylene oxide, residues; and relatively hydrophobic surfactants include alkoxylate surfactants preferably with an average in the range from about 3 to about 10 alkylene oxide, particularly ethylene oxide, residues.

Other suitable surfactants may be selected from those which may be emulsifying, readily miscible, non-gelling, readily dilutable, and/or dispersible.

One example of suitable surfactants may include polysorbates, for example poly alkoxylated sugar alcohol esters. Suitable examples of such surfactants may include typically non-ionic polymeric ether surfactants. The most commonly used examples are polysorbates such as polysorbate 20 and polysorbate 80 (sold under the Tween brand).

In particular a surfactant comprising non-ionic alkoxylate, preferably an alkoxylated fatty alcohol may be included. Said surfactant may act as a dispersant and help disperse the reductant or other components in the concentrate and/or sprayable formulation.

In a one embodiment the non-ionic alkoxylate component is an alkoxylated alcohol of the general formula:

R⁴—O—(AO)ₓ—H (II)

wherein
R⁴ is a straight or branched chain, saturated or unsaturated, substituted or unsubstituted hydrocarbon group having from 4 to 30 carbon atoms,
AO is an oxyalkylene group;
x is an integer of from 1-30.

The oxyalkylene groups (AO) are selected from groups of the formula —(CH_{y}H_{2y}O)—where y is an integer selected from 2, 3, or 4. Preferably, y is an integer selected from 2 or 3.

The oxyalkylene group AO may be selected from oxyethylene, oxypropylene, oxybutylene, or oxytetramethylene. Preferably, the oxyalkylene group is selected from oxyethylene (EO) and oxypropylene (PO).

Where the oxyalkylene chain is homopolymeric, homopolymers of ethylene oxide or propylene oxide are preferred. More preferably, homopolymers of ethylene oxide are particularly preferred.

Where there is more than one oxyalkylene group present (i.e. where x is 2 or more) and at least two are part of the same oxyalkylene chain, the oxyalkylene groups may be the same or may be different along said oxyalkylene chain. In this embodiment, the oxyalkylene chain may be a block or random copolymer of differing oxyalkylene groups. Where the viscosity of the formulation needs to be lowered block or random copolymer of differing oxyalkylene groups in the alkoxylated fatty alcohol may be particularly preferred.

The number of oxyalkylene groups in each oxyalkylene chain (i.e. the value of the each parameter x) will be in the range from 1 to 30. Preferably, in the range from 2 to 25. More preferably, in the range from 3 to 10. Further preferably, in the range from 4 to 7.

The C₄ to C₃₀ hydrocarbyl may preferably be selected from a C₄ to C₃₀ alkyl or a C₄ to C₃₀ alkenyl.

The term ‘alkyl’ as used herein, unless otherwise defined, refers to saturated hydrocarbon radicals being straight chain, branched, or combinations thereof, containing from 4 to 30 carbon atoms. Preferably, the alkyls each contain from 6 to 24 carbon atoms. More preferably, 8 to 22 carbon atoms. Most preferably, 10 to 20 carbon atoms.

Examples of alkyl radicals may be independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl, tetracosyl, pentacosyl, hexacosyl, heptacosyl, octacosyl, or branched variants thereof.

The alkyl radicals may preferably be selected from dodecyl, tridecyl, tetradecyl, pentadecyl, hexadecyl, heptadecyl, octadecyl, nonadecyl, eicosyl, or branched variants thereof.

The term ‘alkenyl’ as used herein, unless otherwise defined, refers to hydrocarbon radicals having at least one or a plurality, preferably no more than four, double bonds.

The alkenyl radicals may be straight chain, or branched moieties, or combinations thereof.

The alkenyl radicals may each contain from 4 to 30 carbon atoms. Preferably, the alkenyls each contain from 5 to 26 carbon atoms. More preferably, 10 to 24 carbon atoms. Most preferably, 16 to 22 carbon atoms.

Examples of alkenyl radicals may be independently selected from ethyl, propenyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenenyl henicosenyl, docosenyl, tricosenyl, tetracosenyl, pentacosenyl, hexacosenyl, heptacosenyl, octacosenyl, or branched variants thereof.

The alkyl radicals may preferably be selected from dodecenyl, tridecenyl, tetradecenyl, pentadecenyl, hexadecenyl, heptadecenyl, octadecenyl, nonadecenyl, eicosenyl, or branched variants thereof.

More preferably, R³ may be derived from, and the residue of a fatty alcohol.

Where R³ is derived from a fatty alcohol, R³ represents an alkoxy group being a residue of a fatty alcohol.

The term ‘residue of a fatty alcohol’ as used herein refers to the moiety that is the resulting product of the fatty alcohol in a particular reaction scheme or subsequent formulation or chemical product, regardless of whether the moiety is actually obtained from the specified chemical species. A ‘fatty alcohol residue’ thereby refers to the moiety which results when a fatty alcohol participates in a particular reaction (i.e. the residue is a fatty alkanol group R—O—). The fatty alcohol residue is therefore ‘derived’ from the respective fatty alcohol. It is understood that this moiety can be obtained by a reaction with a species other than the specified fatty alcohol per se, for example, by a reaction with an unsaturated fatty alcohol chloride, ester, or anhydride.

The fatty alcohols used in the present invention are preferably selected from C₄ to C₃₀ fatty alcohols, more preferably C₆ to C₂₄ fatty alcohols, particularly C₁₀ to C₂₂ fatty alcohols, further preferably C₁₀ to C₁₆ fatty alcohols, and especially C₁₂ fatty alcohols.

The fatty alcohols may be selected from linear or branched fatty alcohols. The fatty alcohols may be selected from saturated or unsaturated fatty alcohols.

Where unsaturated fatty alcohols are present, these may be selected from unsaturated fatty alcohols comprising at least one unsaturated carbon-carbon double bond. Particularly preferred are unsaturated fatty alcohols having in the range from 1 to 3 carbon-carbon double bonds. Most preferred are mono-unsaturated fatty alcohols residues. The carbon-carbon double bond of the fatty chain may be present either in a cis or a trans configuration.

Preferably, the fatty alcohols residues used are derived from linear saturated fatty alcohols.

Those which are miscible with our desired fatty ester composition.

Suitable saturated and unsaturated fatty alcohols in particular may be selected from capryl alcohol pelargonic alcohol, capric alcohol, undecyl alcohol, lauryl alcohol, tridecyl alcohol, myristyl alcohol, pentadecyl alcohol, cetyl alcohol, palmitoleyl alcohol, heptadecyl alcohol, stearyl alcohol, nonadecyl alcohol, arachidyl alcohol, heneicosyl alcohol, or behenyl alcohol, oleyl alcohol, elaidyl alcohol, linoleyl alcohol, linolenyl alcohol, or erucyl alcohol.

In particular, unsaturated and saturated C₁₀ to C₁₆ fatty alcohols may be preferred. The fatty alcohols may preferably be selected from capric alcohol, lauryl alcohol, or myristyl alcohol.

Suitable non-ionic alkoxylates having utility in the context of the present invention may be selected from lauryl alcohol (4 EO) ethoxylate, lauryl alcohol (5 EO) ethoxylate, lauryl alcohol (6 EO) ethoxylate, oleyl (3 EO) ethoxylate, oleyl (5 EO) ethoxylate, or oleyl (10 EO) ethoxylate.

The non-ionic alkoxylates may in particular be selected from those which are miscible with the spray drift reductant.

The term ‘clathrate’ as used herein, unless otherwise defined, refers to a chemical substance which comprises a lattice that traps or contains the relevant molecules, in this case alkoxylated polyol or polyamine which is optionally acyl terminated. Said spray drift reductants, when comprised in said lattice will be understood as being in a ‘clathrated’ form.

Clathrates which may be used for the present invention include in particular urea clathrates or thiourea clathrates. Preferably, urea clathrates are used.

It will be understood that the spray drift reductants which are comprised in the clathrated are the alkoxylated polyol or polyamine, which are optionally acyl terminated, as already defined herein.

The clathrate comprising a spray drift reductant may be used when preparing dry, solid agrochemical formulations, preferably when preparing a nutrient comprising formulation. Clathrates may be preferably included in the agrochemical formulation when including nutrients, especially where the agrochemical formulation is in the form of dry, water soluble, or water dispersible solid.

The method of forming the clathrate comprising the reductant includes the steps of heating, if necessary melting, the reductant to an appropriate temperature, then adding in urea to form a mixture. Preferably the clathrate compound is added at an amount of above 40 wt. % of the mixture, more preferably around 50 wt. %. The mixture is then recrystallised by either i) pouring in to slabs and producing particles by grinding, ii) pastilating it, or iii) spraying of the clathrate to give fine granular solid.

Agrochemically active compounds, in particular systemic insecticides and fungicides, or nutrients require a formulation which allows the active compounds or nutrients to be taken up by the plant/the target organisms.

The term ‘agrochemical formulation’ as used herein refers to compositions including an active or nutrient agrochemical, and is intended to include all forms of compositions, including concentrates and spray formulations. If not specifically stated, the agrochemical formulation of the present invention may be in the form of a concentrate, a diluted concentrate, or a sprayable formulation.

The spray drift reductant may be combined with other components in order to form an agrochemical formulation comprising at least one agrochemical active and/or nutrient.

Accordingly, agrochemical active compounds may be formulated as an emulsifiable concentrate (EC), emulsion concentrate (EW), suspension concentrate (SC), soluble liquid (SL), as an oil-based suspension concentrate (OD), and/or suspoemulsions (SE).

In an EC formulation and in an SL formulation, the active compound may be present in dissolved form, whereas in an OD, SC, or SE formulations the active compound may be present as a solid or emulsified liquid.

It is envisaged that the spray drift reductant of the present invention will particularly find use in a SC, OD, or SE formulation.

The agrochemical formulation of the present invention may be in the form of a concentrate, a diluted concentrate, or a sprayable formulation.

Agrochemical concentrates are agrochemical compositions, which may be aqueous or non-aqueous, and which are designed to be diluted with water (or a water based liquid) to form the corresponding spray formulations. Said compositions include those in liquid form (such as solutions, emulsions, or dispersions) and in solid form (especially in water dispersible solid form) such as granules or powders.

Spray formulations are aqueous agrochemical formulations including all the components which it is desired to apply to the plants or their environment. Spray formulations can be made up by simple dilution of concentrates containing desired components (other than water), or by mixing of the individual components, or a combination of diluting a concentrate and adding further individual components or mixtures of components. Typically such end use mixing is carried out in the tank from which the formulation is sprayed, or alternatively in a holding tank for filling the spray tank. Such mixing and mixtures are typically termed tank mixing and tank mixtures.

A spray drift reductant may therefore be incorporated into the formulation of the agrochemical active or nutrient compound (in-can formulation) or be added after dilution of the concentrated formulation of the spray liquor (tank-mix). To avoid dosage errors and to improve user safety during application of agrochemical products, it is advantageous to incorporate the spray drift reductants into the formulation. This also avoids the unnecessary use of additional packaging material for the tank-mix products.

According to the needs of the customer, concentrates thus formed may comprise typically up to 95 wt. % agrochemical actives or nutrients. Said concentrates may be diluted for use resulting in a dilute composition having an agrochemical active or nutrient concentration of about 0.5 wt. % to about 1 wt. %. In said dilute composition (for example, a spray formulation, where a spray application rate may be from 10 to 500 l·ha⁻¹) the agrochemical active or nutrient concentration may be in the range from about 0.001 wt. % to about 1 wt. % of the total formulation as sprayed.

The spray drift reductant will typically be used either in an amount proportional to the amount of the active agrochemical or nutrient in the formulation, or more preferably in an amount proportional to the volume of spray solution to be applied. In agrochemical formulation concentrates, the proportion of spray drift reductant will depend on the solubility of the components in the liquid carrier. Typically, the concentration of spray drift reductant in such a concentrate will be from 1 wt. % to 99 wt. %. Preferably, from 1 wt. % to 70 wt. %. More preferably, from 3 wt. % to 50 wt. %. Further preferably, from 5 wt. % to 30 wt. %. Most preferably, from 7 wt. % to 20 wt. %.

When concentrates (solid or liquid) are used as the source of active agrochemical and/or spray drift reductant, the concentrates will typically be diluted to form the spray formulations. The dilution may be with from 1 to 10,000, particularly 10 to 1,000, times the total weight of the concentrate of water to form the spray formulation.

Upon dilution to form, for example, a spray formulation, the spray drift reductant will typically be present at a concentration of from 0.001 wt. % to 4 wt. %, more usually from 0.01 wt. % to 1.5 wt. % of the spray formulation. Further preferably, from 0.05 wt. % to 1.0 wt. % of the spray formulation.

Where the agrochemical active is present in the aqueous end use formulation as solid particles, most usually it will be present as particles mainly of active agrochemical.

However, if desired, the active agrochemical can be supported on a solid carrier e.g. silica or diatomaceous earth, which can be solid support, filler or diluent material as mentioned above.

Where the dispersed phase is a non-aqueous liquid, said liquid will typically be an oil. The oil may be or include a mineral oil, including aliphatic (paraffin) mineral oils and aromatic mineral or synthetic oils, such as those sold under the trade name Solvesso; an optionally hydrogenated vegetable oil, such as an optionally hydrogenated cotton seed oil, linseed oil, mustard oil, neem oil, niger seed oil, oiticica oil, olive oil, palm oil, palm kernel oil, peanut oil, perilla oil, poppy seed oil, rape seed oil, safflower oil, sesame oil, or soybean oil; an ester oil (a synthetic ester oil), especially a C₁₆ ester of a C₈ to C₂₂ fatty acid, especially a C₁₂ to C₁₈ fatty acid, or a mixture of esters, such as methyl laurate, 2-ethylhexyl laurate, heptadecanoate, heptadecenoate, heptadecadienoate, stearate or oleate, and in particular methyl laurate and oleate; N-methylpyrrolidone; or an isoparaffin; or a mixture of such oils.

The spray formulations will typically have a pH within the range from moderately acidic (e.g. about 3) to moderately alkaline (e.g. about 10), and particular near neutral (e.g. about 5 to 8). More concentrated formulations will have similar degrees of acidity/alkalinity, but as they may be largely non-aqueous, pH is not necessarily an appropriate measure of this.

The agrochemical formulation may include solvents (other than water) such as monopropylene glycol, oils which can be vegetable or mineral oils such as spray oils (oils included in spray formulations as non-surfactant adjuvants), associated with the reductant. Such solvents may be included as a solvent for the spray drift reductant and/or as a humectant, e.g. especially propylene glycol. When used such solvents will typically be included in an amount of from 5 wt. % to 500 wt. %, desirably 10 wt. % to 100 wt. %, by weight of the spray drift reductant. Such combinations can also include salts such as ammonium chloride and/or sodium benzoate, and/or urea especially as gel inhibition aids.

The agrochemical formulation may also include;
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the composition; and/or
antifoam agents e.g. polysiloxane antifoam agents, typically in amounts of 0.005 wt. % to 1 wt. % of the composition.

Other adjuvants, particularly surfactant adjuvants, may be included in the compositions and formulations of and used in this invention. Examples include linear alcohol alkoxylates (as may be present in materials made for use in this invention derived from linear alcohols in the starting materials); alkylpolysaccharides (more properly called alkyl oligosaccharides); fatty amine ethoxylates e.g. coconut alkyl amine 2EO; sorbitan and sorbitol ethoxylate derivatives, such as those sold under the trade names Atlox and Tween by Croda Europe Limited; derivatives of alk(en)yl succinic anhydride, in particular those described in PCT applications WO 94/00508 and WO 96/16930; and fatty esters of a C3 to C8 polyols.

The agrochemical formulations may also include other components including:
binders, particularly binders which are readily water soluble to give low viscosity solutions at high binder concentrations, such as polyvinylpyrrolidone; polyvinyl alcohol; carboxymethyl cellulose; gum arabic; sugars e.g. sucrose or sorbitol; starch; ethylene-vinyl acetate copolymers, sucrose and alginates,
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, typically at a concentration of from 1 to 10% by weight of the granule; and
viscosity modifiers such as commercially available water soluble or miscible gums, e.g. xanthan gums, and/or cellulosics, e.g. carboxy-methyl, ethyl or propylcellulose.

The agrochemical formulation according to the present invention may also contain components, such as surfactant materials which form part of the system. Said surfactants may include surfactant dispersants.

Suitable surfactants include relatively hydrophilic surfactants, e.g. having a HLB value of greater than 10, preferably greater than 12. The surfactants may alternatively be relatively hydrophobic surfactants being are surfactants which are not fatty esters of C₃ to C₈ polyol or oligomers thereof having 2-5 repeat units, and may have HLB values of less than 10, preferably less than 8.

Relatively hydrophilic surfactants include alkoxylate surfactants with an average in the range from about 10 to about 100 alkylene oxide, particularly ethylene oxide, residues; and relatively hydrophobic surfactants include alkoxylate surfactants preferably with an average in the range from about 3 to about 10 alkylene oxide, particularly ethylene oxide, residues.

Other suitable surfactants may be selected from those which may be emulsifying, readily miscible, non-gelling, readily dilutable, and/or dispersible.

One example of suitable surfactants may include polysorbates, for example poly alkoxylated sugar alcohol esters. Suitable examples of such surfactants may include typically non-ionic polymeric ether surfactants. The most commonly used examples are polysorbates such as polysorbate 20 and polysorbate 80 (sold under the Tween brand).

Suitable agrochemical actives for use in the formulations according to the invention are all agrochemically active compounds, preferably those which are solid at room temperature. It is envisaged that the spray drift reductant of the present invention would have broad applicability to all types of agrochemical actives.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so-called plant growth regulators.

Biocides for use in agrochemical formulations of the present invention are typically divided into two sub-groups:
pesticides, including fungicides, herbicides, insecticides, algicides, moluscicides, miticides and rodenticides, and
antimicrobials, including germicides, antibiotics, antibacterials, antivirals, antifungals, antiprotozoals and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest. A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when sprayed on its surface. A systemic fungicide has to be absorbed by the fungus before the fungus dies.

Examples for suitable fungicides, according to the present invention, encompass the following species: (3-ethoxypropyl)mercury bromide, 2-methoxyethylmercury chloride, 2-phenylphenol, 8-hydroxyquinoline sulphate, 8-phenylmercuri oxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulphide, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulphide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulphate, copper sulphate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulphon, dinoterbon, diphenylamine, dipyrithione, disulphiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulph, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, fluopicolide, fluoroimide, fluotrimazole, fluoxastrobin, fluquinconazole, flusilazole, flusulphamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulphocarb, methfuroxam, methyl bromide, methyl isothiocyanate, methylmercury benzoate, methylmercury dicyandiamide, methylmercury pentachlorophenoxide, metiram, metominostrobin, metrafenone, metsulphovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulphamide fungicides, phosdiphen, phthalide, phthalimide fungicides, picoxystrobin, piperalin, polycarbamate, polymeric dithiocarbamate fungicides, polyoxins, polyoxorim, polysulphide fungicides, potassium azide, potassium polysulphide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfiir, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulphide, spiroxamine, streptomycin, strobilurin fungicides, sulphonanilide fungicides, sulphur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide, and mixtures thereof.

An herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Suitable herbicides may be selected from the group comprising: aryloxycarboxylic acid e.g. MCPA, aryloxyphenoxypropionates e.g. clodinafop, cyclohexanedione oximes e.g. sethoxydim, hydroxybenzonitriles e.g. bromoxynil, sulphonylureas e.g. nicosulphuron, triazolopyrimidines e.g. penoxsulam, triketiones e.g. mesotriones, triazine herbicides such as metribuzin, hexaxinone, or atrazine; sulphonylurea herbicides such as chlorsulfuron; uracils such as lenacil, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxyacetic acids; diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; and/or dihalobenzonitrile herbicides such as bromoxynil, or ioxynil, benzoic acid herbicides, dipyridilium herbicides such as paraquat.

Particularly preferred herbicides may be selected from 2,4-dichlorophenoxyacetic acid (2,4-D), atrazine, dicamba as benzoic acid, glyphosate, glufosinate, imazapic as imidazolinone, metolachlor as chloroacetamide, picloram, clopyralid, and triclopyr as pyridinecarboxylic acids or synthetic auxins, their respective water soluble salts and esters, and mixtures thereof.

An insecticide is a pesticide used against insects in all developmental forms, and include ovicides and larvicides used against the eggs and larvae of insects. Insecticides are used in agriculture, medicine, industry and the household.

Suitable insecticides may include those selected from: chlorinated insecticides such as, for example, Camphechlor, DDT, Hexachloro-cyclohexane, gamma-Hexachlorocyclohexane, Methoxychlor, Pentachlorophenol, TDE, Aldrin, Chlordane, Chlordecone, Dieldrin, Endosulphan, Endrin, Heptachlor, Mirex and their mixtures; organophosphorous compounds such as, for example, Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulphoton, Ethoprop, Fenamiphos, Fenitrothion, Fenthion, Fosthiazate, Malathion, Methamidophos, Methidathion, Methyl-parathion, Mevinphos, Naled, Omethoate, Oxydemeton-methyl, Parathion, Phorate, Phosalone, Phosmet, Phostebupirim, Pirimiphos-methyl, Profenofos, Terbufos, Tetrachlorvinphos, Tribufos, Trichlorfon and their mixture; carbamates such as, for example, Aldicarb, Carbofuran, Carbaryl, Methomyl, 2-(I-Methylpropyl)phenyl methylcarbamate and their mixtures; pyrethroids such as, for example, Allethrin, Bifenthrin, Deltamethrin, Permethrin, Resmethrin, Sumithrin, Tetramethrin, Tralomethrin, Transfluthrin and their mixtures; plant toxin derived compounds such as, for example, Derris (rotenone), Pyrethrum, Neem (Azadirachtin), Nicotine, Caffeine and their mixture; neonicotinoids such as imidacloprid; abamectin e.g. emamactin; oxadiazines such as indoxacarb; and/or anthranilic diamides such as rynaxypyr.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such as moths, slugs and snails. These substances include metaldehyde, methiocarb and aluminium sulphate. A nematicide is a type of chemical pesticide used to kill parasitic nematodes (a phylum of worm).

Particular preference is given to active compounds from the classes of the azole fungicides (azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidol, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforin, triticonazole, uniconazole, voriconazole, viniconazole), strobilurin fungicides (azoxystrobin, dimoxystrobin, fluoxastrobin, kresoxim-methyl, metominostrobin, orysastrobin, picoxystrobin, pyraclostrobin, trifloxystrobin), the SDH fungicides, the chloronicotinyl insecticides (clothianidin, dinotefuran, imidacloprid, thiamethoxam, nitenpyram, nithiazin, acetamiprid, nitenpyram, thiacloprid), the insecticidal ketoenols (spirodiclofen, spiromesifen, spirotetramate), fiproles (fiprole, ethiprole) and butenolides, and also pymetrozine, fluopicolid, N-(3′,4′-dichloro-5-fluoro-1,1′-biphenyl-2-yl)-3-(difluoromethyl)-1-methyl-1H-pyrazole-4-carboxamide and N-{2-[3-chloro-5-(trifluoromethyl)-2-pyridinyl]ethyl}-2-(trifluoromethyl)benzamide. Particular preference is also given to herbicides, in particular sulphonylureas, triketones and herbicidal ketoenols, and also safeners.

In an alternative embodiment the spray drift reductant may be used in formulation comprising nutrients in addition to, or as an alternative to, pesticide actives. In such formulations the nutrient is typically in a dry form. The spray drift reductant may preferably also be in a dry form comprised in a clathrate, with the clathrate admixed with the nutrient.

Nutrients refer to chemical elements and compounds which are desired or necessary to promote or improve plant growth. Suitable nutrients generally are described as macronutrients or micronutrients. Micronutrients typically refer to trace metals or trace elements, and are often applied in lower doses. Macronutrients typically refer to those comprising nitrogen, phosphorus, and potassium, and include fertilisers such as ammonium sulphate, and water conditioning agents.

Suitable nutrients for use in the formulations according to the invention are all nutrient compounds, preferably those which are solid at room temperature. It is envisaged that the spray drift reductant of the present invention would have broad applicability to all types of nutrients. In particular, the spray drift reductants of the present invention when comprised in a clathrate may find particular use with fertilisers, more preferably fertilisers in solid anhydrous form.

Suitable micronutrients include trace elements selected from zinc, boron, chlorine, copper, iron, molybdenum, and manganese. The micronutrients may be in a soluble form or included as insoluble solids, and may be salts or chelated.

Suitable macro nutrients include fertilisers and other nitrogen, phosphorus, potassium, calcium, magnesium, sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for potassium as the nutrient: potassium chloride, sulphate e.g. as mixed sulphate with magnesium, phosphates, particularly potassium dihydrogen phosphate and potassium polyphosphate and less commonly potassium nitrate;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Fertilisers may be included in diluted formulations at relatively low concentrations or as more concentrated solutions, which at very high levels may include solid fertiliser as well as solution.

It is envisaged that inclusion of the nutrient would be dependent upon the specific nutrient, and that micronutrients would typically be included at lower concentrations whilst macronutrients would typically be included at higher concentrations.

When present, the proportion of nutrient in the total concentrate formulation is typically from 5 wt. % to 40 wt. %, more usually, 10 wt. % to 35 wt. %, particularly 15 wt. % to 30, % by weight based on the concentrate.

The invention further includes a method of treating or providing nutrients to plants using spray formulations including at least one dispersed phase agrochemical and a spray drift reductant of the first aspect. The agrochemical may be one or more phytoactives, for example growth regulators and/or herbicides, and/or pesticides, for example insecticides, fungicides or acaricides, or may be a nutrient.

Accordingly the invention further includes methods of use including:
a method of killing or inhibiting vegetation by applying to the vegetation, or the immediate environment of the vegetation e.g. the soil around the vegetation, a spray formulation including at least one dispersed phase agrochemical and a spray drift reductant of the first aspect;
a method of killing or inhibiting pests of plants by applying to the plants or the immediate environment of the plants e.g. the soil around the plants, a spray formulations including at least one dispersed phase agrochemical which is one or more pesticides, for example insecticides, fungicides or acaricides, and a spray drift reductant of the first aspect; and
a method of providing nutrients to vegetation by applying to the vegetation, or the immediate environment of the vegetation e.g. the soil around the vegetation, a spray formulation including at least one nutrient and a spray drift reductant of the first aspect.

Spray drift reductants refer to materials that reduce the amount of undesired small spray droplets (driftable fines) and/or the amount of undesired large droplets, both in a commercially significant and desirable manner. It is understood that the modification of spray drift characteristics is achieved through the modification of the size and size distribution of droplets in the spray.

Spray applied formulations typically exhibit decreasing tendency to drift when a decreased amount of small size spray droplets are formed, that is spray droplets having a droplet size below typically 150 μm. This amount of small driftable droplets may be expressed as a volume percentage of the droplet volume of the total spray applied. There is a desire to reduce the amount of spray drift when compared to formulations either comprising alternative non-ionic surfactants or no spray drift reductant. Spray drift of pesticides can have undesirable consequences which include unintended contact of phytotoxic pesticides with non-pest pest plants causing damage to these non-pest plants, such as crops or ornamental plants.

In addition, use of the spray drift reductants of the present invention results in no or few extremely large droplets being created which might otherwise be expected when using polymer surfactants in agrochemical formulations.

The present invention will be understood to improve spray droplet characteristics with none or little degradation of spray pattern.

It will be understood that all values of particle and droplet size stated herein are with reference to the TeeJet 8002 spray nozzle 80° and the flow rate is 0.2 gallons per minute. Fluid pressure for spray testing is stated at 40 psi unless stated otherwise. Values for spray drift reduction are with reference to spray formulations comprising 0.125 wt. % of the reductant.

Droplet size and spray measurement values may be readily determined by laser light scattering, image analysis, or phase doppler laser measurement. Droplet size measurements as used in the present application are with reference to measurement by laser light scattering using a Sympatec Helos Vario KF laser sizing system. The spray plume was directed down and traversed across the instrument laser beam; data was averaged over the spray plume.

Preferably the spray drift reductant decreases the volume of driftable fine droplets (fines). In particular, driftable fine droplets are those which are of size less than 150 μm, where this is understood by ASTM 1519 to represent the droplet size below which the droplets are driftable.

The reduction in spray drift will be therefore understood as a reduction in the volume percentage of droplets having a droplet size of less than 150 μm compared to an analogous agrochemical formulation which does not comprise the spray drift reductant of the present invention.

The spray drift reductant of the present invention may provide a percentage reduction of droplets having a size of less than 150 μm of at least 5% at a spray pressure of 40 psi. More preferably, at least 10%. Further preferably, at least 15%. Most preferably, at least 20%.

Further reduction of particularly small droplets, those having a size of less than 105 μm is provided by the present invention.

The spray drift reductant of the present invention may provide a percentage reduction of droplets having a size of less than 105 μm of at least 5% at a spray pressure of 40 psi. More preferably, at least 10%. Further preferably, at least 15%. Most preferably, at least 20%.

In the form of a distribution of particle sizes, the spray droplet would have a median volume particle/droplet diameter value. It will be understood that the median volume particle diameter refers to the equivalent spherical diameter corresponding to the point on the distribution which divides the population exactly into two equal halves. It is the point which corresponds to 50% of the volume of all the particles, read on the cumulative distribution curve relating volume percentage to the diameter of the particles i.e. 50% of the distribution is above this value and 50% is below. This value is referred to as the ‘D(v,0.5)’ value and is determined as described herein.

Preferably the spray drift reductant increases the D(v,0.5) value. The increase in the D(v,0.5) of the spray will be therefore understood as an increase in the spray droplet median volume particle/droplet diameter value compared to an analogous agrochemical formulation which does not comprise the spray drift reductant of the present invention.

The spray drift reductant of the present invention may provide a percentage increase of the D(v,0.5) value of at least 2% at a spray pressure of 40 psi. More preferably, at least 4%. Most preferably, at least 6%.

The spray drift reductant of the present invention, by reducing the amount of undesired small and large droplets, may change the droplet size distribution of a sprayed formulation.

The width of the droplet size distribution may be defined as the ‘span’ which is a measure of the width of the distribution based on the 10%, 50% and 90% quantile.

Span (measured in μm) may be defined as follows:

Span=D(v,0.9)−D(v,0.1)

and relative span (RS, unitless) may be defined as follows:

$$Span = \frac{D ( v , 0.9 ) - D ( v , 0.1 )}{D ( v , 0.5 )}$$

The volume median diameter D(v,0.5) is the as defined herein. ‘D(v,0.9)’ and ‘D(v,0.1)’ values are the equivalent spherical diameter corresponding to 90% or 10% respectively of the volume of all the particles, read on the cumulative distribution curve relating volume percentage to the diameter of the particles, i.e. they are the points where 10% or 90% of the distribution is above this value and 90% or 10% are below the value respectively.

The relative span value represents the width of the particle size distribution of the spray droplets, and therefore how defined the distribution is around the median particle size value. It has been found that using the spray drift reductant of the present invention spray droplet size distribution is more narrowly defined around the desired range.

The spray drift reductant of the present invention may provide for a narrower relative span in comparison to a sprayed agrochemical formulation not comprising reductant.

The percentage reduction in relative span is at least 2% at a spray pressure of 40 psi. More preferably, at least 3%. Further preferably, at least 4%. Most preferably, at least 5%.

The ‘drift reduction efficiency’ is defined as the amount of reduced drift obtained per 1 wt. % of the reductant present, the value using as a base line an identical formulation comprising no reductant. As noted, the reduction in spray drift can be seen by the reduction in the volume percentage of droplets having a droplet size of less than 150 μm compared to an analogous agrochemical formulation which does not comprise the spray drift reductant of the present invention. Therefore, a value for drift reduction efficiency can be calculated by measuring the difference in the volume percentage of droplets having a droplet size of less than 150 μm for a reductant comprising formulation compared to a control, and calculating a value per 1 wt. % of reductant. For example, if the percentage difference found for use of 0.2 wt. % reductant is 10%, the calculated drift reduction efficiency value would be 50 per 0.1 wt. % reductant.

The drift reduction efficiency for the reductant is preferably greater than 1, more preferably greater than 3, even more preferably greater than 10, further preferably greater than 20, particularly preferably greater than 30, more preferably greater than 40, even more preferably greater than 50, further preferably greater than 70, most preferably greater than 100.

All of the features described herein may be combined with any of the above aspects, in any combination.

In order that the present invention may be more readily understood, reference will now be made, by way of example, to the following description.

It will be understood that all tests and physical properties listed have been determined at atmospheric pressure and room temperature (i.e. 20° C.), unless otherwise stated herein, or unless otherwise stated in the referenced test methods and procedures.

Compounds as used in the following examples are identified as follows:

Reductant—

PEG-50 sorbitol (453 g, 31.2 wt. %) and poly-12-hydroxystearic acid (997 g, 68.8 wt. %) were charged in to a stainless steel reaction vessel. The mixture was heated to 210-220° C. under nitrogen spare and agitation. The reaction was held for 4-5 hours. The reaction was then cooled to 70-80° C. with the product (R1) discharged.

The following test method was used to determine corrosion performance of the adjuvant compositions

Spray Parameters—

Spray droplet size distributions were measured in the Croda recirculating low speed wind tunnel apparatus (LSWT). During operation of the recirculating wind tunnel a column of air was directed down through the spray chamber which measured 48 in (wide) by 30 in (deep) by 48 in (tall). Solutions were prepared by percent weight in deionized water and sprayed from a TeeJet 8002 flat fan nozzle at 40 psi with wind moving vertically downward along the spraying axis at 15 mph. Spent spray solution was removed using a mist eliminator.

Spray droplets were detected and sizes measured with a Sympatec HELOS-Vario/KR laser diffraction system equipped with an R7 lens that intersects the spray perpendicular to the spraying axis approximately 10 inches below the nozzle exit. To ensure the full droplet size distribution is detected, data was collected continually as the nozzle traversed across the laser sampling region at 8 in/s.

Traverse of the spray head extended 50 inches on either side of the laser. D(v,0.1) is the micron size (μm) at which 10 percent of the spray volume is of the reported size and smaller. D(v,0.5) and D(v,0.9) are similar statistics. The percent less than 105 μm (% <105 μm) and 150 μm (% <150 μm) are the percentages of the spray volume that is 105 μm and smaller or 150 μm and smaller, and the greater than 400 μm (%>400 μm) is the percentage of droplets larger than 400 μm. The results reported here represent the average and standard deviation of at least three measurements of the droplet size distribution for each sample.

### Dilute Spray Formulations

Reductant compound R1 was diluted in water at various strengths and then sprayed to obtain particle size and distribution results, and therefore determine spray drift properties. The results are shown in Table 1. The values reported are the average of at least four measurements.

TABLE 1
Dilute formulation of R1

| % w/w | D(v, 0.1)/ | D(v, 0.5)/ | D(v, 0.9)/ | | % < 105 | % < 150 | % > 400 |
|---|---|---|---|---|---|---|---|
| R1 | μm | μm | μm | VMD | μm | μm | μm |
| 0 | 105.10 | 224.53 | 364.11 | 231.69 | 9.98 | 23.00 | 5.78 |
| 0.007813 | 119.39 | 239.16 | 383.02 | 246.04 | 7.08 | 18.16 | 7.68 |
| 0.015625 | 120.18 | 241.03 | 385.39 | 248.10 | 6.99 | 17.75 | 7.92 |
| 0.03125 | 116.96 | 237.99 | 381.22 | 244.87 | 7.60 | 18.56 | 7.50 |
| 0.0625 | 118.55 | 236.88 | 375.66 | 243.57 | 7.21 | 18.38 | 6.89 |
| 0.125 | 120.82 | 239.80 | 380.21 | 246.47 | 6.89 | 17.47 | 7.30 |
| 0.25 | 118.26 | 236.98 | 379.22 | 244.21 | 7.27 | 18.47 | 7.23 |
| 0.5 | 111.72 | 227.66 | 376.26 | 238.64 | 8.38 | 21.25 | 7.21 |

VMD—volume mean diameter.

As can be seen from the results, the percentage of small particles (those less than 150 μm and less than <105 μm) is significantly reduced (20% or more) for samples which contain R1 when compared to the control (where the percentage of R1 is 0). The spray drift reduction effect can be seen even at low concentrations of R1.

### Active Formulations

A number of formulations were made up comprising:
R1 at 0.125 wt. %
Total active at 1 wt. % (this was a 40% active solution)
Water to balance to 100 wt. %

The results are shown in Tables 2-4.

TABLE 2
2,4-D formulations (average of at least three measurements)

| Spray | | | | | % < 105 | % < 150 | % > 400 |
|---|---|---|---|---|---|---|---|
| Solution | D(v, 0.1)/μm | D(v, 0.5)/μm | D(v, 0.9)/μm | VMD | μm | μm | μm |
| C1 | 96.78 | 215.07 | 350.99 | 220.93 | 12.22 | 26.28 | 4.35 |
| F1 | 105.18 | 228.04 | 377.35 | 235.80 | 9.95 | 22.51 | 7.20 |

C1—1% ae 2,4-D DMA
F1—1% ae 2,4-D-DMA and 0.125% R1

TABLE 3
glyphosate formulations (average of at least three measurements)

| Spray | | | | | % < 105 | % < 150 | % > 400 |
|---|---|---|---|---|---|---|---|
| Solution | D(v, 0.1)/μm | D(v, 0.5)/μm | D(v, 0.9)/μm | VMD | μm | μm | μm |
| C2 | 85.08 | 195.83 | 344.05 | 206.66 | 16.38 | 32.50 | 4.24 |
| F2 | 104.70 | 214.42 | 355.41 | 224.59 | 10.09 | 25.09 | 5.21 |

C2—1% ae fully loaded k-glyphosate
F2—1% ae fully loaded k-glyphosate and 0.125% R1

TABLE 4
2,4-D and glyphosate formulations (average of at least three measurements)

| Spray | | | | | % < 105 | % < 150 | % > 400 |
|---|---|---|---|---|---|---|---|
| Solution | D(v, 0.1)/μm | D(v, 0.5)/μm | D(v, 0.9)/μm | VMD | μm | μm | μm |
| C3 | 88.36 | 202.40 | 347.63 | 211.70 | 14.93 | 30.34 | 4.50 |
| F3 | 95.01 | 206.06 | 351.94 | 217.15 | 12.90 | 28.31 | 5.09 |

C3—0.5% ae fully loaded k-glyphosate and 0.5% ae 2,4-D DMA
F3—0.5% ae fully loaded k-glyphosate and 0.5% ae 2,4-D DMA and 0.125% R1

It can be seen from the results in Tables 2-4 that in the active containing formulations the reduction in fine particles is significant in the presence of a reductant of the present invention (R1) when compared to the control formulations having no R1.

It is to be understood that the invention is not to be limited to the details of the above embodiments, which are described by way of example only. Many variations are possible.

1. A sprayable agrochemical formulation comprising;
i) at least one spray drift reductant is an alkoxylated polyol or polyamine which is optionally acyl terminated;
ii) optionally non-ionic alkoxylate; and
ii) optionally at least one agrochemical active and/or nutrient;
wherein said formulation comprises in the range from 0.001 wt. % to 4 wt. % of the reductant.

2. The formulation according to claim 1, wherein the spray drift reductant has a general structure (I):
R¹.[(AO)ₙ—R²]ₘ (I)
wherein
R¹ is the residue of a polyol or polyamine, each said polyol or polyamine having m active hydrogen atoms, where m is an integer of at least 2;
AO is an oxyalkylene group;
each n independently represents an integer in the range from 1 to 100;
each R² is independently represents hydrogen, or an acyl group represented by —C(O)R³ wherein each R³ independently represents a residue of polyhydroxyalkyl carboxylic acid, polyhydroxyalkenyl carboxylic acid, hydroxyalkyl carboxylic acid, hydroxyalkenyl carboxylic acid, oligomer of hydroxyalkyl carboxylic acid, or oligomer of hydroxyalkenyl carboxylic acid; and
wherein on average at least two R² groups per molecule are alkanoyl groups as defined.

3. The formulation according to claim 2, wherein R¹ is the residue of, or a residue derived from a monosaccharide, a disaccharide or a higher oligosaccharide.

4. The formulation according to claim 2, wherein R¹ is the residue of a monosaccharide selected from glucose, fructose or sorbitol.

5. The formulation according to claim 2, wherein the oxyalkylene group AO is selected from oxyethylene, oxypropylene, oxybutylene, or oxytetramethylene.

6. The formulation according to claim 2, wherein the value of the each parameter n is in the range from 2 to 50.

7. The formulation according to claim 2, wherein total number of alkylene oxide residues in general structure (I) (i.e. n×m) is in the range from 10 to 300.

8. The formulation according to claim 2, wherein where each R³ independently represents a residue of hydroxylalkyl and hydroxyalkenyl carboxylic acids of formula HO—X—COOH where X is a divalent saturated or unsaturated aliphatic radical containing at least 8 carbon atoms and no more than 20 carbon atoms, and in which there are at least 4 carbon atoms directly between the hydroxyl and carboxylic acid groups.

9. The formulation according to claim 8, wherein the hydroxyalkyl carboxylic acid is 12-hydroxystearic acid.

10. The formulation according to claim 1, wherein the spray drift reductant is a liquid with a molecular weight ranging from 3,000 to 8,000.

11. The formulation according to claim 1, wherein the non-ionic alkoxylate is an alkoxylated fatty alcohol.

12. The formulation according to claim 1, wherein the non-ionic alkoxylate is an alkoxylated alcohol of the general formula:
R⁴—O—(AO)ₓ—H (II)
wherein
R⁴ is a straight or branched chain, saturated or unsaturated, substituted or unsubstituted hydrocarbon group having from 4 to 30 carbon atoms,
AO is an oxyalkylene group;
x is an integer of from 1-30.

13. The formulation according to claim 1, wherein the non-ionic alkoxylate is selected from lauryl alcohol (4 EO) ethoxylate, lauryl alcohol (5 EO) ethoxylate, lauryl alcohol (6 EO) ethoxylate, oleyl (3 EO) ethoxylate, oleyl (5 EO) ethoxylate, or oleyl (10 EO) ethoxylate.

14. A concentrate formulation suitable for making a sprayable agrochemical formulation according to claim 1, said concentrate comprising a spray drift reductant of an alkoxylated polyol or polyamine which is optionally acyl terminated.

15. A sprayable agrochemical formulation comprising;
i) in the range of from 0.001 wt. % to 4 wt. % spray drift reductant, wherein the reductant is an alkoxylated polyol or polyamine which is optionally acyl terminated, and is capable of reducing spray drift by at least 10%; and
ii) at least one agrochemical active and/or nutrient.

16. (canceled)

17. A method of reducing spray drift by using an agrochemical formulation according to claim 1.

18. A method of treating vegetation to control pests and/or to provide nutrients, the method comprising applying a formulation according to claim 1 either to said vegetation or to the immediate environment of said vegetation.
